(19) United States
(12) Patent Application Publication
(10) Pub. No.: US 2009/0192880 A1
(43) Pub. Date: Jul. 30, 2009

(54) Method of Providing Leads From a Trustworthy

(76) Inventors: Michael Hood, Irvine, CA (US); Michael Khristo, Irvine, CA (US)

Correspondence Address: FISH & ASSOCIATES, PC;ROBERT D. FISH, 2603 Main Street, Suite 1000, Irvine, CA, 92614-6232, US

(21) Appl. No.: 12/356,032

(22) Filed: Jan. 19, 2009

Related U.S. Application Data
(63) Continuation-in-part of application No. 12/355,997, filed on Jan. 19, 2009.
Application No. 12/355,997 is a continuation-in-part of application No. 12/355,983, filed on Jan. 19, 2009.
(60) Provisional application No. 61/022,484, filed on Jan. 21, 2008.
(60) Provisional application No. 61/022,486, filed on Jan. 21, 2008.
(60) Provisional application No. 61/024,792, filed on Jan. 30, 2008.

(51) Int. Cl. G06Q 30/00; G06Q 10/00; G06Q 50/00

(52) U.S. Cl. 705/10; 705/26

(57) ABSTRACT

Methods of providing leads are presented. A lead database storing leads is made available, possibly via a lead mining service, where leads comprise closing values and attributes that have attributes values or attribute metadata describing the attributes. Lead purchasers can modify the closing values or attributes of the leads as they work the leads. An analytics engine can derive one or more value drivers for a lead purchaser based on a multi-varitate analysis of the closing values and attributes of the leads. Sources of leads can be assigned trust scores that indicate a measure of confidence that the source can provide leads according to the purchaser's value drivers.

This application is a continuation-in-part of U.S. patent application having Ser. No. 12/355,997, filed on Jan. 19, 2009, which is a continuation-in-part of U.S. patent application having Ser. No. 12/355,983, filed on Jan. 19, 2009, which claims the benefit of priority to U.S. provisional applications having Ser. No. 61/022,484 and 61/022,486 both filed on Jan. 21, 2008; and this application claims the benefit of priority to U.S. provisional application having Ser. No. 61/024,792 filed on Jan. 30, 2008. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is lead providing technologies.

### BACKGROUND

Leads can be purchased and sold through various lead providing services including those offered by Leadpile™ (http://www.leadpile.com). Unfortunately, Leadpile or other lead providing services offer weak guidance to lead purchasers regarding the quality of leads. This is especially true when lead purchasers have different criteria or perspectives on lead quality. A preferred lead providing service should offer lead purchasers multiple perspectives on the quality of leads as opposed to merely indicating if a lead has “high” quality or not. Ideally an entity that obtains leads (e.g., a lead purchaser) should gain insight into the quality of the leads corresponding to one or more their value drivers, and gain insight with respect to how trustworthy a lead source is at providing leads according to the value drivers.

Some progress has been made to toward aiding lead purchasers to determine if leads meet their needs. For example, U.S. patent application publication US2006/0041500 to Diana et al. titled “System for Implementing Automated Open Market Auctioning of Leads” and U.S. patent application publication US2006/0265259 also to Diana et al. titled “ ”Automated Attachment of Segmentation Data to Hot Contact Leads for Facilitating Matching of Leads to Interested Lead Buyers”, both describe automated lead exchange systems that utilize lead buyer profiles to match leads with purchasers. In the contemplated systems, lead sellers are rated with respect to the quality of the leads that they provide. If a lead seller supplies inferior leads, their selling prices are discounted. Although useful for increasing revenue of leads by matching active leads to lead purchasers, the contemplated systems fail to objectively determine value drivers for a lead purchaser and fail to indicate if lead sellers can be trusted to supply desirable leads for such value drivers.

In other fields of endeavor beyond lead marketplace technologies, effort has been directed establishing some level of trustworthiness for various. For example, U.S. patent application publication US2008/0275719 to Davis et al. titled “Trust-Base Rating System” describes a system where individuals can rate goods, services, people, or other items according to different criteria. The raters can then form a network of trust where trust ratings from a first user are weighted by a weighting factor representing how much other users trust the first user. Such an approach is effective when the users of the network are well know to each other, but becomes impractical in environments where users are largely unaffiliated as in a lead market place.

European patent application EP2000934 to applicant Philips titled “A Reputation System for Providing a Measure of Reliability on Health Data” offers some insight into alternative approaches to determining a trustworthiness of a source of goods or services. A reputation of a health data provider is rated according to a rating element. If the aggregate rating is over a threshold, the provider is deemed to be reliable. However, such an approach fails to take into account that users of the system can have different perspectives on makes the data providers reliable.

Additionally, U.S. patent application publication US2007/0106577 to Kopp et al. titled “Apparatus and Method for Facilitating Trusted Business Intelligence” takes trust a step further by presenting users with multiple trust values for various attributes of a business report. A user can also be supplied with an aggregate trust value of a report. The approach taken by Kopp allows for a fine grained understanding of a trustworthiness of a report with respect to the report's attributes. However, Kopp also fails take into account that desirable attributes, or combination of attributes, can be different from one user to another.

Interestingly, the use of trust has not yet been applied to leads and to participants within a lead market place (e.g., leads sources, lead purchasers, lead sellers, etc.). A lead market place should offer lead purchasers several aids to help the purchaser identify leads that align with their specific value drivers and to help the purchaser obtain leads from lead sources that can be trusted to provide leads that align with the purchaser's value drivers. Furthermore, such a market place should be able to objectively identify the value driver based on the various attributes or closing values of the leads.

Thus, there is still a need for systems, methods, configuration, or apparatus that aid a lead purchaser to identify leads from a trustworthy source and offer such leads to others.

### SUMMARY OF THE INVENTION

The inventive subject matter provides apparatus, systems and methods in which a leads from a lead source can be offered for sale to a lead purchaser according one or more trust scores associated with the lead source. In one aspect of the inventive subject matter, a lead database is provided, possibly through a lead mining service, which stores leads that are available to others including lead purchasers. Leads preferably comprise one or more closing values and one or more attributes describing the leads. In a preferred embodiment, lead attributes includes a tag and an attribute value associated with the tag. Furthermore, lead attributes beneficially include attribute metadata that describe a lead's attribute. As users work leads, the users can update leads by modifying the lead's various attributes or by modifying the closing values of the leads as the leads flow through the contemplated system. The closing values, attributes, attribute values, and metadata can be analyzed, preferably automatically through an analytics engine, to derive one or more value drivers for a lead purchaser. Lead sources can be assigned a trust score for one or more of the value drivers to offer the purchaser insight into how trustworthy a source is for providing leads having desirable characteristics that align with the purchaser's value drivers. When a lead source submits new leads for purchase, a lead purchaser can view the offered leads via a purchasing interface where the leads can be presented according to the trust values of one or more lead sources.

In some embodiments, a rating interface is provided to allow an individual to assign validation ratings to the leads where the ratings indicate a perceived validity of the lead with respect to the various value drivers. The validation ratings can be aggregated to form a validity score for one or more leads in a group or individually. A validity score can be assigned to a lead, or a group of leads, for each value driver. In some embodiments, lead sources can also rate the validity of the lead. Therefore, the validation rating of a lead source, or other individual for that matter, can be adjusted according the lead source's trust scores. The validity scores, along with the trust scores and value drivers, can be presented to a lead purchaser through a lead purchasing interface.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a lead mining service that stores leads in a lead mining database.

FIG. 2 presents an example of a lead having attributes that comprise attribute values and attribute metadata.

FIG. 3A presents a graphical example of deriving a value driver from lead closing values, lead attributes, and lead metadata.

FIG. 3B presents a listing of example value drivers that have been derived.

FIG. 4 is a schematic of a rating interface through which a user can assign a validation rating to one or more leads.

FIG. 5 is a schematic of a lead purchasing interface that presents leads according to trust scores of lead sources.

FIG. 6 is a schematic of a method for providing a set of leads for purchase.

### DETAILED DESCRIPTION

### Lead Mining Service Overview

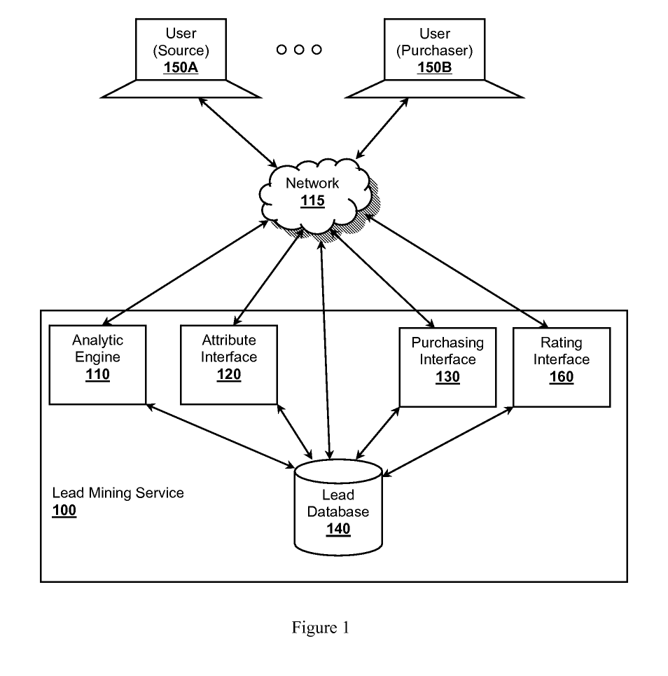

FIG. 1 presents an overview of an environment where lead mining service 100 offers access to leads to one or more users 150A through 150B, collectively referred to as users 150. A preferred lead mining service 100 comprises analytic engine 110, attribute interface 120, purchasing interface 130, or rating interface 160. Leads can be stored in lead database 140 and offered to users 150 directly from database 140 or indirectly possibly through the various intermediary elements (e.g., engine 110, or interfaces 120, 130, or 160) of service 100. In a preferred embodiment, leads are provided to users 150 over network 115, possibly the Internet.

As used herein, the term “interface” is used to represent a computing device configured to execute software instructions stored on a computer readable medium (e.g., RAM, flash, hard disks, solid state disks, etc.) where the computing device provides the functionality of the described interface. It should be appreciated “interfaces” are considered to include hardware specifically adapted via software. For example, an interface can be implemented via a web server that serves a web page to a computer rendering the page via a browser, a personal computer running a local software application presenting user interface (e.g., a GUI) to the user, an computer offering an Application Program Interface (API) locally to a user's software package, a remote computer offering an API available over a network (e.g., a web service), or a one or more computer systems operating as a Software-as-a-Service (SaaS) implementation.

Lead mining service 100 preferably comprises a for-fee lead providing service. A preferred lead mining service is disclosed in parent U.S. patent application having Ser. No. 12/355,983 titled “Lead Mining, Systems and Methods”. Such approaches to lead mining are embodied by manyUP™ Corporation of Newport Beach, Calif. (http://www.manyup.com) through which leads can be exchanged, distributed, or re-monetized. In the manyUP model, multiple unaffiliated users work leads substantially in parallel. As users 150 work a lead, users 150 modify attributes of the leads, which can improve the lead's monetary value (e.g., the lead's price) to others.

Lead mining service 100 can be embodied by other services or software packages. For example, service 100 could include a Customer Relationship Management (CRM) software package only available internally to a business entity, or externally to multiple business, possibly comprising a Software-as-a-Service (SaaS) CRM that integrates the disclosed techniques. An example CRM SaaS that could benefit from integrating the contemplated adaptive lead pricing system includes SalesForce.com™ (http://www.salesforce.com).

Users 150 represent entities that participate with lead mining service 100. Users 150 can include lead buyers (i.e., purchaser 150B), lead sellers (i.e., lead source 150A), lead aggregators, CRM providers, lead management systems, or even lead mining services. Users 150 can be embodied by businesses, people, computer systems, or even lead mining service 100. The term “lead purchaser” is used euphemistically within this document to represent a user having the objective to obtain to obtain leads or has obtained a set of leads. It should be appreciated that a lead purchaser does not necessarily have to purchase leads.

In a preferred embodiment, users 150 interact with service 100 over network 115. Network 115 preferably comprises the Internet through which unaffiliated users 150 can access leads in service 100. However, network 115 can also comprise other, more private networks including a LAN, WAN, WLAN, VPN, or other forms of networks, wired or wireless.

Preferred lead mining services 100 also comprise an analytic engine 110. A preferred analytic engine 110 comprises one or more computing devices configured to execute software instructions stored on a computer readable media that are configured to analyze leads flowing through a preferred lead mining service. As used herein, the term “engine” is used to represent a computing device storing software instruction on a computer readable medium (e.g., RAM, flash, hard disks, solid state disks, etc.) where the computing device executes the software instructions to provide the functionality of the analytic engine. As with interfaces, one should appreciated the “analytic engine” is considered to include hardware specifically adapted via analysis software as discussed below.

An analytic engine 110 is preferably configured to track an attribute's attribute value or attribute metadata as a function of time among many different leads that are assigned the attribute. As users 150 work leads by modifying lead attributes or attribute metadata, the engine can derive trends or relationships among the attributes, attribute values, attribute metadata, or acceptable closing values for one or more users. The analytic engine 110 can utilize one or more algorithms to derive relationships or correlations. Contemplated algorithms include automated multi-variate testing algorithms that track closing value of leads with respect to attributes, attribute values, or metadata. Suitable multi-variate testing that can be incorporated into the analytics engine includes the Taguchi method, which is ordinarily used for quality management. Other acceptable multi-variate testing can be incorporated including regression analysis, canonical variate analysis, principle components analysis, linear discriminate analysis, logistic regression, artificial neural networks to establish non-linear variates, multidimensional scaling, recursive partition, or other analysis methods. In a preferred embodiment, an analytic engine 110 can establish linear relationships as well as non-linear relations.

Preferred leads stored on database 140 comprise a closing value and one or more attributes where each attribute includes a tag describing the attribute, an attribute value that corresponds to the tag, or attribute metadata describing the attribute. Attribute Interface 120 is preferably configured to allow users 150 to modify a lead's attributes while users 150 work the leads. In a preferred embodiment, the attributes of a lead can be modified by updating an attribute, adding an attribute to a lead, removing an attribute of a lead, defining or creating new attributes, or otherwise altering attributes of a lead. An attribute can be updated via attribute interface 120 by modifying the attribute's tag, attribute value, or attribute's metadata. A suitable attribute interface is disclosed in parent U.S. patent application having Ser. No. 12/355,997 titled “Adaptive Lead Pricing”.

Lead mining service 100 preferably offers leads by presenting the leads to others via purchasing interface 130. A user 150 can view leads with according to the user's specific value drivers, according to trust scores associated with lead sources, or according to perceived validity of the leads. An example purchasing interface is discussed below. Additional information regarding a suitable lead purchasing interface can also be found in U.S. patent application having Ser. No. 12/355,997 titled “Adaptive Lead Pricing”.

Lead mining service 100 can also include lead rating interface 160 through which leads can be rated with respect to one or more rating scales. In a preferred embodiment, users 150 use rating interface 160 to assign a validation rating to a lead to indicate how the user perceives the validity of the lead with respect to a value driver as discussed below.

Leads are preferably stored within database 140 on a storage system (e.g., memory, hard disk, solid state disk, RAID system, SAN, NAS, etc.). Database 140 can be implemented using any suitable database system, possibly including MySQL™, Microsoft™ Access™, Oracle™, Postgres SQL™, or other database systems. Database 140 preferably provides capability for searching for leads based on one or more attributes of a lead. In some embodiments, leads are stored as an N-tuple with respect to lead attributes which provides for ease of retrieval for analysis by analytic engine 110. However, any suitable schema for searching, storing, or exchanging leads can be used. It is also contemplated that leads can be serialized or stored using XML as method to exchange leads among one or more third party software packages beyond those available from service 100.

Leads, Lead Attributes, Attribute Values, Attribute Metadata

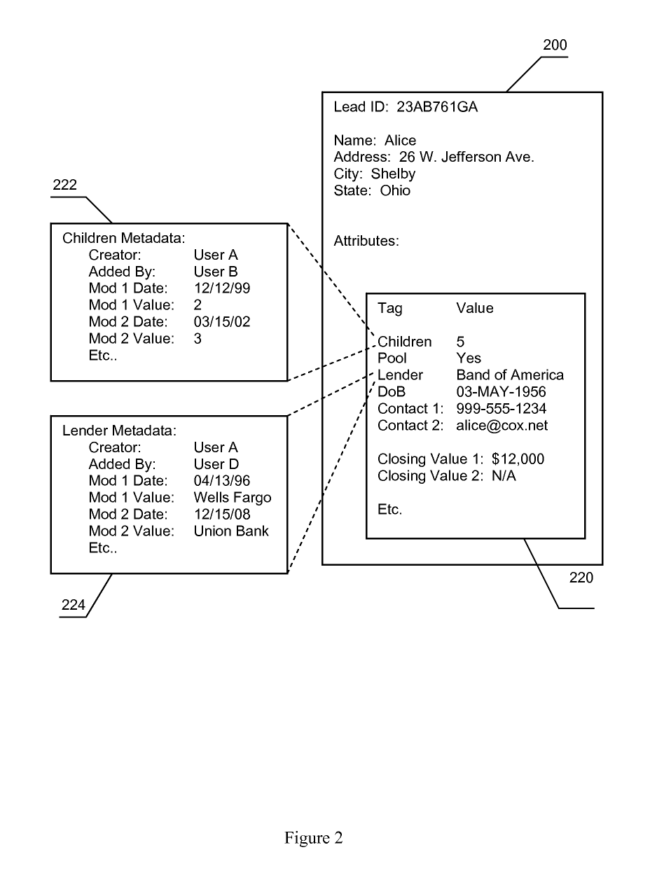

FIG. 2 illustrates an example of a preferred lead 200. Lead 200 can include data describing an individual (e.g., a person, company, organization, etc.) that has expressed interest in obtaining information regarding goods or services. In a preferred embodiment, lead 200 comprises data representing demographic information including name, address, contact information, or other data used to identify the individual associated with the lead. Lead 200 can also include data describing other aspects of the individual including psychographic information, socioeconomic information, or other information that might be of interested to users 150.

Lead 200 preferably comprises one or more of lead attributes 220. A lead attribute can also include attribute metadata. For example, attribute metadata 222 comprises information that describes attribute 220 having the tag “Children”. Attribute metadata 224 has information that describes attribute 220 have the tag “Lender”. Attributes 220 provide additional information for users of a lead mining service when working a lead, and provide data that can be analyzed to establish or derive one or more value drivers for a lead purchaser. One should appreciate that lead attributes can be considered in some embodiments as distinct data objects that can be directly stored with lead 200 or stored separately from lead 200, but referenced by lead 200, possibly through an identifier (e.g., an attribute pointer, GUID, UUID, etc.).

Attributes 220 preferably comprise a tag and one or more attribute values associated with the tag. In some embodiments a tag/value is pair is sufficient. It should be noted that the attribute value could encode any desirable value. Consider the case of the following three similar, yet different, attributes: “Children”, Children:”, or “Children?”. Each of these attributes could have different values. In the case of “Children”, the existence of the attribute might be sufficient even if no attribute value is associated with the tag, or the attribute value could be set to NULL. In the case of “Children:”, the associated attribute value could be any integer value: 0, 1, 2, 3, 4, etc., for example. In the case of “Children?”, the associated attribute value could be considered a Boolean value or “True” or “False”, or possibly “Yes” or “No”. All possible encoded data types are contemplated as an attribute value.

In a preferred embodiment, attributes 220 also comprise attribute metadata (e.g., attribute metadata 222 or 224) that provide detailed information about an attribute 220. Example attribute metadata includes information relating to the creator of the attribute, the individual that assigned an attribute to lead 200, an attribute modification history, attribute access permissions, or other forms of metadata relating to the attribute. Consider the examples shown in FIG. 2. In both cases of attribute metadata 222 and 224, the “Children” attribute and “Lender” attribute have metadata that provides a detailed history of the attribute. The attribute history, or any other information, provides yet additional data for establishing trends or deriving value drivers for a lead purchaser. Although attribute metadata 222 and 224 are shown as having tag/value pairs, it should be noted that any other data structure can be used to store attribute metadata as desired.

A preferred lead 200 also includes one or more closing values that indicate an end result of working lead 200. It is contemplated that closing values can be stored with lead 200 as a lead attribute 220 as shown. A preferred closing value represents a monetary value that can in turn be used by analytic engine 110 to establish profitable trends as leads are worked or as leads flow through a preferred lead mining service. However, a lead's closing value can take on non-monetary values well. For example, a political candidate might close a lead with a closing value of “Agreed to Vote”.

One should note that lead 200 can comprise more than one closing value. A first closing value could be set by a first lead purchaser upon closing a lead where a second closing value might be set by a second, different lead purchase when they close the lead. Preferred lead mining services 100 track or store closing value histories for use by analytic engine 110. In such embodiments, multiple closing values can be distinguished from each other by their corresponding attribute metadata. The metadata also provides for securing closing value information from other purchasers by encoding access permission within the attribute metadata. For example, the first purchaser's closing value can be meta-tagged with a token (e.g., password, GUID, UUID, secret key, etc.) that indicates the first purchaser is permitted to access or view of the closing value. If a purchaser has a corresponding token or passes appropriate authentication or authorization protocols, the purchase can access the closing values, or other attributes. The second purchaser would lack such permission and would therefore lack access or lack visibility of the first closing value.

The demographic information of lead 200 is shown outside of attributes 220 for clarity purposes. It should be appreciated that such information can also be encoded as attributes.

Value Drivers

As leads are worked by lead purchasers, or other users, a lead's attributes and their corresponding attribute values or attribute metadata are likely modified to reflect a current state of the lead. Furthermore, a lead purchaser can set one or more closing values of the lead possibly when they complete work on the lead representing a final disposition of the lead.

In a preferred embodiment, a lead mining service include an analytic engine that objectively tracks the various lead data as time passes or as leads are worked. The analytic engine preferably conducts one or more analyses on the lead data to establish trends or to derive value drivers for the lead purchaser. Valued drivers can be derived by establishing correlations between lead closing values and combinations of lead attributes, attribute values, or attribute metadata. Such correlations can be established by conducting multi-variate analysis as discussed above, preferably based on the Taguchi method, on the leads and their data. A value driver is considered to comprise at least one attribute and its attribute value or its attribute metadata. A more complex value driver can comprise a first attribute, a second attribute and its attribute value, and a third attribute and its metadata, where the first, second, and third attributes are different attributes.

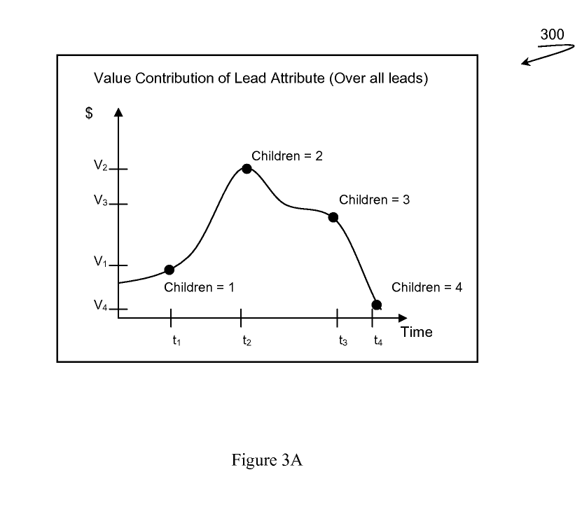

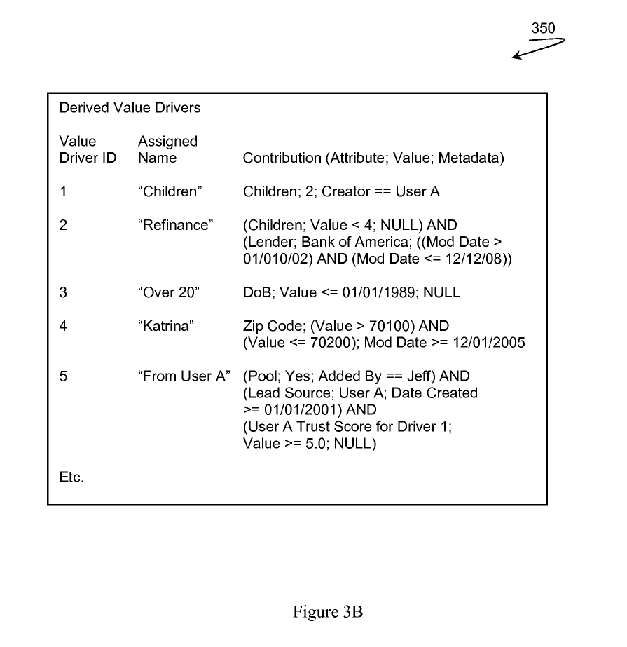

FIG. 3A presents a schematic of value driver analysis in the form of graph 300. In the simple example shown, an analytic engine determines that a value driver for a lead purchaser comprise leads having an attribute of “Children” and an attribute value of 2 to 3. Furthermore, the value driver can depend on attribute metadata that indicates that attribute value changes from a value of 1 to 2 within a time period of t₂-t₁ (e.g., the attribute value's history). The result of the analysis can be presented to a lead purchase to illustrate that they can maximize their benefit by pursuing leads that will likely have two children after a the time period t₂-t₁. One should note that the example presented is a simple example and that a preferred embodiment is capable of generating more complex value drivers having multiple parameters across multiple attributes and their corresponding metadata or attribute values. Such value drivers are objectively derived as opposed to being defined by the lead purchaser a prior. Such an approach ensures that a lead purchaser does not accidentally introduce bias for which leads they obtain.

FIG. 3B presents an example listing 350 of value drivers that could be derived from analyzing leads flowing through a lead mining service. In a preferred embodiment, value drivers are treated as a data object that can be accessed within the system, and preferably comprise an identifier (e.g., number, GUID, UUID, etc.), by which a lead purchaser, or other authorized users, can access or view the value driver.

The value drivers in listing 350 can take on many different from simple value drivers (e.g., depends on a single attribute) to complex value drivers (e.g., depends on multiple attributes). Driver 1, for example, is a simple value driver that comprising a single attribute, “Children”, with a value of “2” and attribute metadata indicating the creator of the attribute is “User A”. Value driver 4 represents a more complex driver comprising multiple attributes and has a more programmatic structure where parameters of the value drivers are joined by operators (e.g., AND, NOT, OR, XOR, etc.). In driver 4, the value driver indicates that leads where a zip code changed from a New Orleans zip code before December, 2005, would likely have value to a lead purchaser, possibly due to hurricane Katrina.

Although value drivers preferably comprise attributes, attribute values and/or attribute metadata, value drivers can also include other aspects. For example, Driver 5, a more complex value driver, is a combination of multiple attributes, their attributes values or metadata, and a trust score of a lead source. Trust scores are discussed below.

Value drivers can be specific to a lead purchaser or common across multiple, unaffiliated lead purchasers (e.g., lead purchasers owned, operated, or employed by different entities). Specific values drivers can be derived based solely on closing values or attributes associated with a specific lead purchaser, possibly identified through attribute metadata. Common value drivers can be derived based on lead data available across multiple lead purchasers that are in a common industry, possibly mortgage brokers for example.

In some embodiments, lead purchasers, or other users, can assign names to the value drivers by which they can reference the drivers. For example, driver 1 could be simply named “Children”, driver 2 could be named “Refinance”, driver 3 could be named “Over 20”, or driver 4 could be named “Katrina Victim”. It should be appreciated that each lead purchaser could have different names for a common value driver. For example, another lead purchaser could name driver 4 as “Hurricane Victim”.

It is also contemplated that value drivers can include a temporal nature where the value driver is considered relevant for a limited life time. Value drivers having a life time can arise due to seasonal market changes, natural events (e.g., earthquakes, tornados, etc.), news events, or other occurrences. Value driver life times can be less than one year, perhaps due to seasonal changes, and can including one month, three months, six months, or other time frames. Naturally, value driver life times can also be longer than one year, possibly to reflect various life stages of individuals associated with the leads. For example, an individual referenced in a lead might be in college and might be expected to graduate within the next four years, at which point the individual might be interested in car or house loans.

An astute reader will appreciate that the disclose subject matter can also be utilized to generate negative value drivers that indicate aspects of leads that have little or no value to a lead purchaser. Negative value drivers can be used to filter unwanted or undesirable leads. Such an approach also falls within the scope of the inventive subject matter.

In some embodiments, value drivers can be used to identify markets, market segmentation, or market specialization. For example, if multiple lead purchasers have one or more common, or at least similar, value drivers, then they likely participate in a common market place. In such embodiments, a lead mining service can utilize the market segmentation information to place advertisements targeting the lead purchasers. Such an approach provides for generating additional revenue for the lead mining beyond providing a lead market place. It should be noted that the inventive subject matter is considered to include identifying market segmentations or using market segmentation derive value for a lead mining service.

Lead Source Trust Scores

In a preferred embodiment, a lead purchaser's value drivers can be employed for more than indicating which leads are useful to the lead purchaser. The value drivers can also be used to identify lead sources that can be trusted to supply leads that align with the purchaser's value drivers. As used herein “trust score” is used to indicate a measure of confidence, perceived or real, that a lead source supplies leads that align with the objectives of a lead purchaser. Trust is differentiated from “validity”, which means the data is considered to be true (e.g., perceived true or validated as true).

As a lead source (e.g., a lead seller, lead aggregator, lead mining service, etc.) offers leads to others, the history of the leads supplied by the lead source can be analyzed with respect to the value drivers of the lead purchaser. If the leads from the source align with the value drivers, then the source can be assigned a trust score to indicate the source is a trusted source for such leads.

In a preferred embodiment, the contemplated lead mining service automatically assigns an objective trust score to a lead source for at least some of the lead purchaser's value drivers. It is also contemplated that users could rate the trustworthiness of a lead source with respect to value drivers. The trust ratings can be aggregated together to form an aggregate trust score of the lead source for each value driver, or to form a single aggregated trust score for the lead source across all value drivers, specific or common.

A trust score can be single valued or multi-valued. A single valued trust score can simply be a normalized value from 1 to 10, or any other score, possibly as an average over all trust ratings. One example multi-valued trust score can include an average trust score value, and a measure of precision with which the value was determined. For example, a trust score could be an average over 1,000 individual trust scores falling within a distribution (e.g., Gaussian, Poisson, etc.) The measure of precision could be the width of the distribution, or other characteristic of a distribution. Another example of a multi-value trust score includes an array of scores values where each score corresponds to the trust score of a source at a specified time. It is also contemplated that the trust score could also carry metadata that describes the trust score. Contemplated trust score metadata includes trust score age, number of trust ratings used to derive the trust score, trust score history, or any other trust score information.

Trust scores can be calculated and assigned to a lead source using any suitable method. One suitable method includes tracking the history of leads originating from the lead source to determine the leads closing values from many lead purchasers. The attributes of the leads can be compared against the value drivers of a first lead purchaser. If there is a similarity or a match between the attributes and value drivers, the lead source's trust score for that value driver is improved, possibly by incrementing the trust score. If the lead's attributes do not match or lack similarity to a value driver, the lead source's corresponding trust score can be reduced or remain unchanged. In a preferred embodiment, trust scores for a value driver are normalized (e.g., normalized to a scale to a scale of 10, 100, a percent, etc.) across multiple lead sources to provide lead purchasers an indication of the relative merits between sources.

Other methods of calculating trust scores can also be performed. Another suitable method of calculating a trust score can include adjusting the trust score based on observed trust metrics associated with a lead source. A trust metric represents various aspects of past behavior of a lead source and can include historical activity of the source, revenue generated from source's leads, rated value of the source's leads, number of leads sold, or number of leads purchased. A lead source's trust metrics can be improved or reduced as desired in respond to the metrics. For example, if a lead source has an active history within a lead mining service, its trust scores could be improved over a second lead source with similar leads matching a value driver, but lacking a history. Such improvements in a trust score can be considered an award for contributing valuable leads to the lead marketplace and can be used to rank a lead source ahead of others.

A lead source can have many different trust scores corresponding to value drivers associated with different lead purchasers. Such trust scores can be restricted from view based on the lead purchaser's available information. In a preferred embodiment, a lead purchaser would only have access to the lead source's trust scores that correspond to the purchaser's value drivers. Access to trust scores can be controlled by encoding access permissions within a trust score's metadata.

Trust scores also represent data available to an analytic engine. As leads are worked, it is expected that trust scores could also change as time passes or as leads are worked. The analytic engine can use such information to identify trends with respect to lead sources or can fold the trust scores into deriving value drivers as discussed above. It is specifically contemplated that trust scores can be presented to users as a function of time to allow lead purchasers to see how lead sources improve, or not improve, over time.

Rating Interface

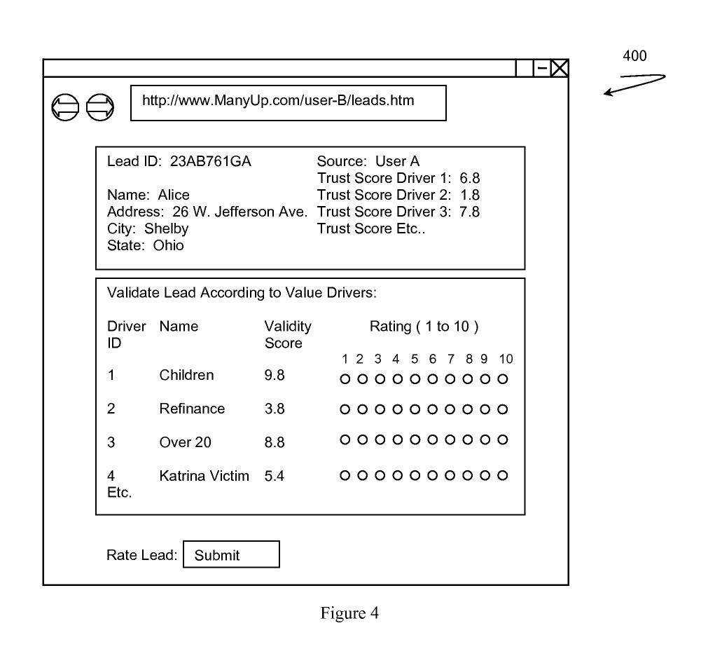

In some embodiments, a lead mining service can include a lead rating interface, possibly similar to rating interface 400 shown in FIG. 4. Interface 400 can be used to rate the validity of a lead with respect to derived value drivers. Preferably the rating corresponds to a perceived validity indicating how true the user believes that the lead corresponds to the value drivers. It is contemplated that interface 400 can present a lead along with trust scores assigned to the source of the lead. It should be appreciated that rating interface 400 can be other types of interfaces other than a web page as shown. Interface 400 can also include computing devices configured to offer web services, SaaS implementations, APIs, GUIs, or other types of interfaces.

As shown, the value drivers of the lead purchaser are also shown with the value drivers' corresponding validity scores, possibly aggregated from other users. The lead purchaser can also rate that the validity of the lead by assigning a validation rating to the lead with respect to the value drivers. The validation rating can be aggregated with previously assigned validation ratings to arrive at the validity score. The aggregated validly score can then be assigned back to the lead. The validity score can be an average over the previously assign validation ratings. In a preferred embodiment, the validation ratings assigned by the user are altered based on the trust scores assigned to the user. For example, if a lead source rates its own lead as having a high validation rating, but the lead source has a very low trust score for the corresponding value driver, the validation rating's rating contribution to the validity score can be reduced by reducing the weight of the rating. It is also contemplated that validation ratings from a lead source can also be overweighed if the lead source is considered trustworthy. Such an approach aids in preventing a lead source from gaming the system by artificially inflating the validity score of leads.

Validity scores can also be calculated using any suitable algorithm as a single valued score or as a multi-valued score as discussed with respect to trust scores above.

Although the validity score is shown on a per lead basis, it should be appreciated that a validity score can also be applied to a group or pool of leads. The validity scores of a group of leads can be presented as an aggregate score according to each value driver, or a single score aggregated across multiple value drivers. A single aggregated score across multiple value drivers can be calculated by average all the validity scores of the value drivers, possibly by weighting the individuals scores according to the relative contribution from each value driver.

Validity scores can also provide valuable feedback to a lead mining service's analytic engine. As users assign validation ratings to leads with respect to derived value drivers, the analytic engine can determine the accuracy with which it identified the value derived. The analytic engine can then begin to weight contributions to the value drivers as a function of the validity scores. One such approach is to adjust a weighting of attributes, attribute values, or attribute metadata. For example, if such parameters are to be common across value drivers, then it would be likely such parameters carry more weight and might contribute more strongly to other value drivers.

Validity scores aid a lead purchaser by providing an indication of how others perceive the veracity of the lead, especially with respect to one or more value drivers. By providing both trust scores of lead sources and validity scores of leads, a lead purchaser can make well informed decisions about obtaining leads. In a preferred embodiment, leads are presented to a lead purchaser via a purchasing interface.

Lead Purchasing Interface

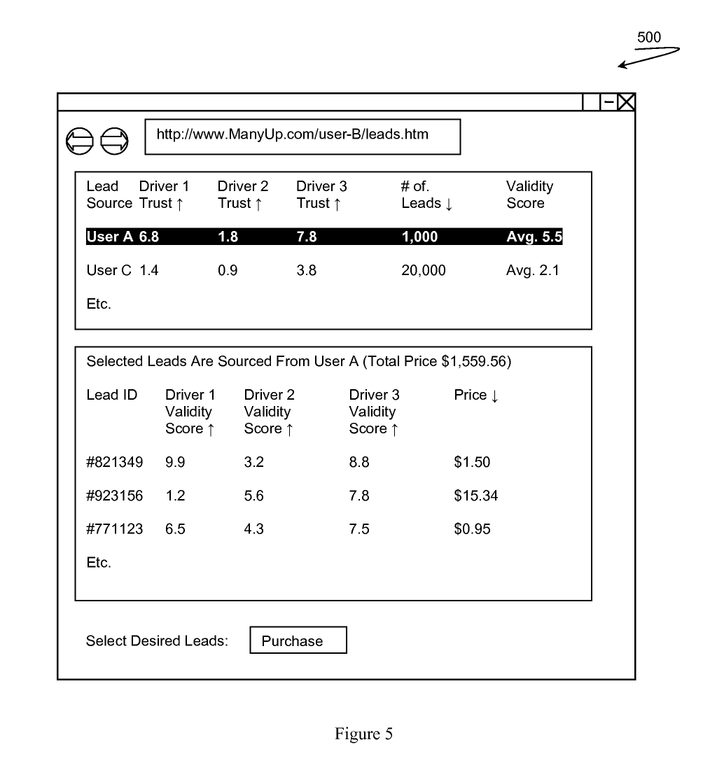

In FIG. 5, a lead purchaser can obtain, or purchase, one or more leads via lead purchasing interface 500. In a preferred embodiment, purchasing interface 500 is configured to offer leads from a lead source to a lead purchaser according to the trust scores assigned to the lead source. In the example shown, leads from lead sources User-A, User-C, or others are presented along with their individual trust scores according the value drivers of the lead purchaser. Although purchasing interface 500 is shown as a web page, it should be appreciated that interface 500 take on a different form while still falling in the scope of the inventive subject matter. For example, interface 500 could a computer device configured to offer a web services API, a software GUI, a SaaS implementation, or other types of interfaces.

Purchasing interface 500 can also present leads along with their validity scores according the value drivers. As shown, a lead purchaser has highlighted leads offered from source User A. The leads from User-A are presented according to their validity scores. Although interface 500 shows individual leads presented with respect to their validity scores for the various value drivers, it is also contemplated that a group or pool of leads could be presented according aggregated validity scores corresponding to the various value drivers. Leads can be presented in any desirable form including as a spreadsheet, a data file, graphically as a tag cloud, or other desirable format.

In a preferred embodiment, leads can be ranked by the lead mining service according their value drivers and their corresponding trust scores as shown. The leads can then be presented to the lead purchaser via purchasing interface 500. Preferably the lead purchaser can sort the leads to rank them as desired by selecting a sort method. As shown, the leads can be ranked in ascending or descending order by selecting the “↑” or “↓” symbols respectively. All methods of ranking or sorting leads according to their value drivers, trust scores, or validity scores are contemplated.

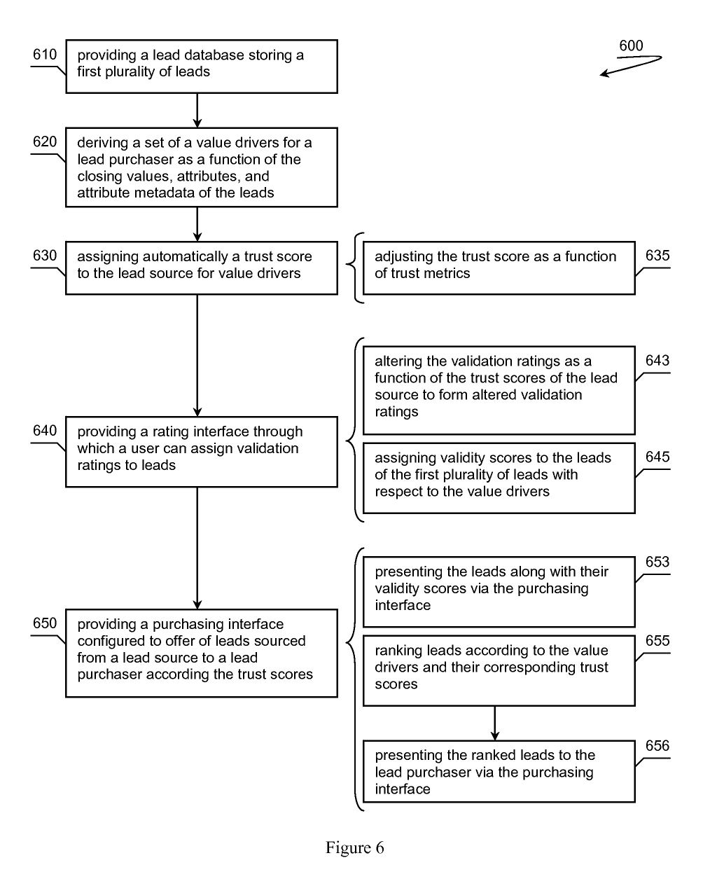

In FIG. 6, method 600 describes an embodiment where a set of leads is offered to a lead purchaser. In a preferred embodiment, a lead mining service employs one or more computer systems configured to execute software instructions stored on computer readable media to perform the steps of method 600.

A step 610, preferably a lead mining service provides a lead database storing a plurality of leads, preferably where the leads comprise closing values and attributes having attribute values or attribute metadata. As users of the lead mining service work leads, the leads' attributes or closing values can be modified.

At step 620, a set of value drivers are derived, preferably by an analytic engine, as a function of the closing values, attributes, attribute values, or attribute metadata of the leads. In a preferred embodiment, the value drivers are derived objectively based on establishing correlations between the closing values of the leads and a combination of lead attributes, attribute values, or attribute metadata through multi-varitate testing.

Furthermore at step 630, trust scores are preferably automatically assigned by the lead mining service to lead sources for at least some of the value drivers. It is specifically contemplated that a lead source will have multiple trust scores relating to value drivers from a plurality of different lead purchasers. In a preferred embodiment, the trust scores can be adjusted at step 635 as a function of observed trust metrics associated with the lead source.

At step 640, it is contemplated that a lead mining service can provide a rating interface through which a user can assign one or more validation ratings to the leads, preferably according to the value drivers associated with the user. In embodiments where a lead source can rate their own leads, at step 643 the validation ratings can be altered as a function of trust scores of the lead source. The alerted validation rating can then be aggregated with other previously assigned validating ratings from other users to form a validity score for the lead and corresponding value drivers. A step 645, the validity scores are assigned to the leads with respect to at least some of the value drivers.

At step 650, a purchasing interface is provided that is configured to offer leads originating from a lead source to a lead purchaser. Preferably the leads are presented to the lead purchaser according to the trust scores of the lead purchaser. In some embodiments, at step 653 leads are presented to a lead purchaser along with their validity scores. Additionally, leads can be ranked at step 655 according to a lead purchaser's value drivers, or according to the lead source's trust scores for the value drivers. Furthermore, the ranked leads can also be presented to the lead purchaser via the purchasing interface at step 656.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing a set of leads from a trustworthy source, the method comprising:
providing a lead database storing a first plurality of leads from a lead source, each lead comprising a closing value and an attribute having an attribute value and attribute metadata;
deriving a set of a value drivers for a lead purchaser as a function of the closing values, attributes, and attribute metadata where each value driver comprises at least one attribute, the attribute value of the one attribute, and attribute metadata of the one attribute;
assigning automatically a trust score to the lead source for each of at least some of the of value drivers; and
providing a purchasing interface configured to offer a second plurality of leads sourced from the lead source to the lead purchaser according the trust scores.

2. The method of claim 1, further comprising providing a rating interface through which a user can assign validation ratings to leads of the first plurality of leads with respect to the value drivers.

3. The method of claim 2, wherein the user is the lead source.

4. The method of claim 3, further comprising altering the validation ratings as a function of the trust scores of the lead source to form altered validation ratings.

5. The method of claim 4, further comprising assigning validity scores to the leads of the first plurality of leads with respect to the value drivers by aggregating previously assigned validation ratings with the altered validation ratings, and presenting the first plurality of leads along with their validity scores via the purchasing interface.

6. The method of claim 5, wherein the validity scores are multi-valued.

7. The method of claim 1, wherein at least one value driver comprises at least two of the following: a first lead attribute, an attribute value from a second lead attribute, and attribute metadata from a third lead attribute where the first, second, and third attributes are different from each other.

8. The method of claim 1, wherein at least one value driver is common among the lead purchaser and a second, unaffiliated lead purchaser.

9. The method of claim 1, wherein at least one value driver further comprises at least one trust score of the lead source.

10. The method of claim 1, further comprising tracking a plurality of trust metrics associated with the lead source.

11. The method of claim 10, wherein the trust metrics include at least one of the following historical activity, revenue generated, leads rated, leads sold, and leads purchased.

12. The method of claim 10, wherein the step of assigning the trust scores further includes adjusting the trust score as a function of the trust metrics.

13. The method of claim 1, wherein the trust scores are multi-valued.

14. The method of claim 1, further comprising ranking the second plurality of leads according to the value drivers and their corresponding trust scores, and presenting the ranked second plurality of leads to the lead purchaser via the purchasing interface.
